(19) United States
(12) Patent Application Publication
(10) Pub. No.: US 2026/0220591 A1
(43) Pub. Date: Jul. 30, 2026

(54) SYSTEMS AND METHODS FOR REDUCING STORAGE RESOURCE UTILIZATION OF STAGNANT ITEMS

(71) Applicant: Walmart Apollo, LLC, Bentonville, AR (US)

(72) Inventors: Pradeep Dattatray Kadnor, Nashik (IN); Megha Ahuja, Bangalore (IN); Himanshu Gupta, Bangalore (IN); Nidhi Ns, Bangalore (IN)

(21) Appl. No.: 19/041,813

(22) Filed: Jan. 30, 2025

(51) Int. Cl. G06Q 10/087; G06Q 30/0601

(52) U.S. Cl. CPC G06Q 10/087; G06Q 30/0631; G06Q 30/0633

(57) ABSTRACT

Systems and methods for utilizing an artificial intelligence (AI) model to reduce storage resource utilization. One such method including receiving data associated with a plurality of stagnant items determined inactive for a threshold time. The method further includes, using an AI model trained using data related to the plurality of stagnant items, analyzing the data associated with the plurality of stagnant items to identify at least one candidate item of the plurality of stagnant items for including in a bundling option. The method further includes generating a bundling recommendation including the bundling option, wherein the bundling option includes the at least one candidate item. The method further includes presenting the bundling recommendation along with an acceptance indicator for accepting the bundling recommendation and a rejection indicator for rejecting the bundling recommendation.

### BACKGROUND

Various retailers rely on suppliers to provide them with products to sell to their customers. Accordingly, the suppliers will keep items in stock in their warehouse or storage facilities in order to quicky and efficiently provide the items to the retailer when called upon. Keeping items in stocks for their retailer partners can be a cost-intensive task for suppliers, as it can require the suppliers to significantly invest in associated inventory resources, such as storage space, maintenance programs, inventory management systems, and warehouse personnel, for example. Accordingly, suppliers strive to only temporarily hold items in stock at their storage facilities, with the ultimate goal of offloading their stock items to retailers, as holding items in stock for too long can lead to an inefficient use of the supplier's limited inventory resources. Additionally, retailers also benefit from suppliers being as efficient as possible in their management of inventory items, as any waste or inefficiencies experienced by the supplier is often passed on to and realized by the retailers.

### SUMMARY

The disclosed examples are described in detail below with reference to the accompanying drawing figures listed below. The following summary is provided to illustrate some examples disclosed herein.

The scope of this disclosure includes various systems and methods for utilizing an artificial intelligence (AI) model to reduce storage resource utilization. One such method including receiving data associated with a plurality of stagnant items determined inactive for a threshold time. The method further includes, using an AI model trained using data related to the plurality of stagnant items, analyzing the data associated with the plurality of stagnant items to identify at least one candidate item of the plurality of stagnant items for including in a bundling option. The method further includes generating a bundling recommendation including the bundling option, wherein the bundling option includes the at least one candidate item. The method further includes presenting the bundling recommendation along with an acceptance indicator for accepting the bundling recommendation and a rejection indicator for rejecting the bundling recommendation.

### BRIEF DESCRIPTION OF THE DRAWINGS

The disclosed examples are described in detail below with reference to the accompanying drawing figures listed below:

FIG. 1 illustrates an exemplary block diagram of a system for generating recommendations for selling unsold items;

FIG. 2 is a block diagram illustrating an example architecture, executable by the system of FIG. 1, for generating recommendations for selling unsold items;

FIG. 3 is a block diagram illustrating how the architecture of FIG. 2 determines stagnant items of a supplier and generates selling recommendations;

FIGS. 4A and 4B illustrate example factors considered to determine stagnant items of a supplier;

FIG. 5 illustrates an example user interface displayed on a supplier device of the architecture of FIG. 2;

FIG. 6 illustrates an example user interface displayed on a retailer interface of the architecture of FIG. 2;

FIG. 7 illustrates an example chatbot function of the architecture of FIG. 2;

FIG. 8 is a flowchart illustrating a method generating recommendations for selling unsold items of the architecture of FIG. 2;

FIG. 9 is a flowchart illustrating a method generating recommendations for selling unsold items and including interactions between the various components of the architecture of FIG. 2; and

FIG. 10 is a block diagram illustrating an exemplary operating environment where the architecture of FIG. 2 can be implemented.

Corresponding reference characters indicate corresponding parts throughout the drawings.

### DETAILED DESCRIPTION

Suppliers keep items in stock in their warehouse or storage facilities in order to quicky and efficiently provide the items to their partner retailers when called upon. Keeping items in stocks for their retailer partners can be a cost-intensive task for the suppliers, as it can require the suppliers to significantly invest in associated inventory resources, such as storage space, maintenance programs, inventory management systems, and warehouse personnel, for example. Accordingly, suppliers strive to only temporarily hold items in stock at their storage facilities, with the ultimate goal of offloading their stock items to retailers, as holding items in stock for too long can lead to an inefficient use of the supplier's limited inventory resources. Additionally, retailers also benefit from suppliers being as efficient as possible in their management of inventory items, as any waste or inefficiencies experienced by the supplier is often passed on to and realized by the retailers.

Thus, when suppliers hold items in stock for an extended period of time, the stagnant items can be a financial burden on the supplier, causing an increase in the suppliers' inventory costs. Any efforts that can be made to turnover the inventory would benefit not only the supplier, but also the retailer, as the financial burden associated with the stagnant items would not be passed to the retailer. Offering the items for sale through the retailer to their customers at a discounted price or as part of a promotional deal could allow the stagnant inventory to be offloaded from the supplier, but would need to ideally be done in a way that still allows for the supplier and retailer to gain a profit from the stagnant inventory. Many factors must be considered in determining an appropriate discounted price or promotional deal for the stagnant inventory.

Aspects of the disclosure solve multiple problems that are necessarily rooted in computer technology, and render use of computing platforms more efficient in common use cases by providing bundling options and recommendations for offloading stagnant items from a supplier's inventory. Specifically, the disclosure allows suppliers to provide information regarding their inventory to a supplier hub operated by a retailer. The hub determines stagnant items and utilizes an artificial intelligence (AI) model to analyze the stagnant items and determine bundling options for selling the stagnant items. The AI model can be trained with various data related to the stagnant items, such as market trends, market value data, and user demands, for example, to generate the bundle options. Interactive user interfaces for both the suppliers and retailer can then be updated with the results to accept, reject, or edit the bundle options. This significantly improves communication between suppliers and retailers, as stagnant items are automatically identified by the systems disclosed and the parties are automatically informed of the stagnant items. Additionally, the systems herein generates bundle options for selling the stagnant items using generative AI models, rather than the retailer or supplier having to estimate a best selling price or promotion for selling the stagnant items.

The various examples will be described in detail with reference to the accompanying drawings. Wherever preferable, the same reference numbers will be used throughout the drawings to refer to the same or like parts. References made throughout this disclosure relating to specific examples and implementations are provided solely for illustrative purposes but, unless indicated to the contrary, are not meant to limit all examples.

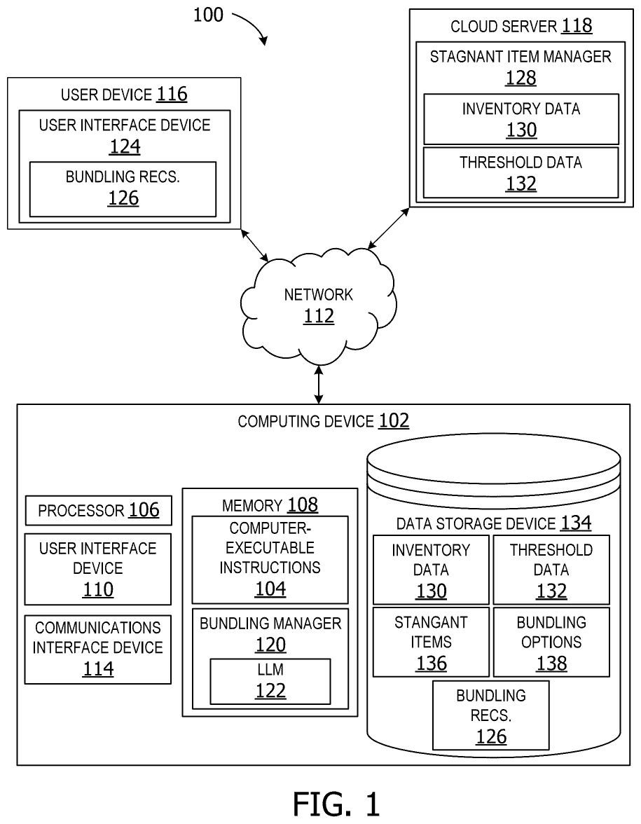

FIG. 1 illustrates an exemplary block diagram of a system 100 for generating recommendations for selling unsold items. In the example of FIG. 1, the computing device 102 represents any device executing computer-executable instructions 104 (e.g., as application programs, operating system functionality, or both) to implement the operations and functionality associated with the computing device 102. The computing device 102, in some embodiments includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some embodiments, the computing device 102 has at least one processor 106 and a memory 108. The computing device 102, in other embodiments includes a user interface device 110.

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some embodiments, processor 106 is programmed to execute instructions such as those illustrated in the figures.

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other embodiments, the memory 108 is external to the computing device (not shown) or both (not shown). The memory 108 can include read-only memory and/or memory wired into an analog computing device.

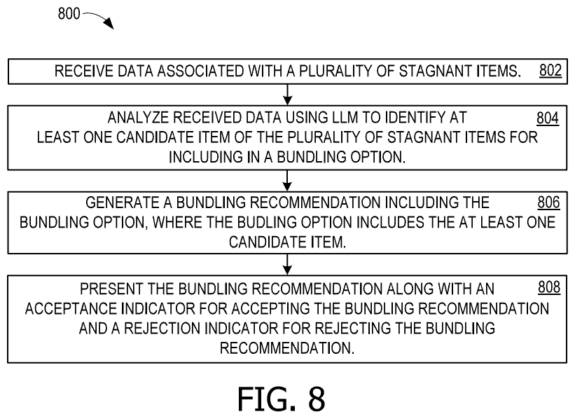

The memory 108 stores data, such as one or more applications, such as a bundling manager component 120 configured to utilize a large language model (LLM) 122, to determine stagnant items and generate associated bundling options and recommendations for selling the stagnant items by performing various operations and methods discussed herein, such as method 800 discussed in FIG. 8, for example. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other embodiments, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, In other embodiments, the network 112 is a local or private LAN.

In some embodiments, the system 100 optionally includes a communications interface device 114. The communications interface device 114 includes a network interface card and/or computer-executable instructions (e.g., a driver) for operating the network interface card. Communication between the computing device 102 and other devices, such as but not limited to user device 116, can occur using any protocol or mechanism over any wired or wireless connection. In some embodiments, the communications interface device 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface device 124 for presenting various information to a user, such as bundling recommendations 126 generated by bundling manager component 120, for example.

The cloud server 118 is a logical server providing services to the computing device 102 or other clients, such as, but not limited to, the user device 116. The cloud server 118 is hosted and/or delivered via the network 112. In some non-limiting examples, the cloud server 118 is associated with one or more physical servers in one or more data centers. In other embodiments, the cloud server 118 is associated with a distributed network of servers. Cloud server 118 can host a stagnant item manager 128 which stores and delivers inventory data 130 associated with a supplier's inventory items, and also threshold data 132 which compromises threshold values defining the amount of time particular items are desired to remain in the supplier's inventory before the items are defined as stagnant items. The inventory data 130 and threshold data 132 are delivered by the stagnant item manager 128 to computing device 102 where the data is utilized by bundling manager component 120 in determining stagnant items and generating associated bundling options and recommendations.

The system 100 can optionally include a data storage device 134 for storing data, such as, but not limited to, retailer-and/or supplier-related data associated with users of system 100. For example, data storage device 134 can store inventory data 130 and threshold data 132 received from stagnant item manager 128; and stagnant items 136, bundling options 138 and bundling recommendations 126 generated by bundling manager component 120. The data storage device 134 can include one or more different types of data storage devices, such as, for example, one or more rotating disks drives, one or more solid state drives (SSDs), and/or any other type of data storage device. The data storage device 134 in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other embodiments, the data storage device 134 includes a database.

The data storage device 134 in this example is included within the computing device 102, attached to the computing device, plugged into the computing device, or otherwise associated with the computing device 102. In other embodiments, data storage device 134 includes a remote data storage accessed by the computing device via the network 112, such as a remote data storage device, a data storage in a remote data center, or a cloud storage. Similarly, although bundling manager component 120 is depicted within computing device 102, according to various embodiments, bundling manager component 120 is implemented on a remote or cloud memory storage.

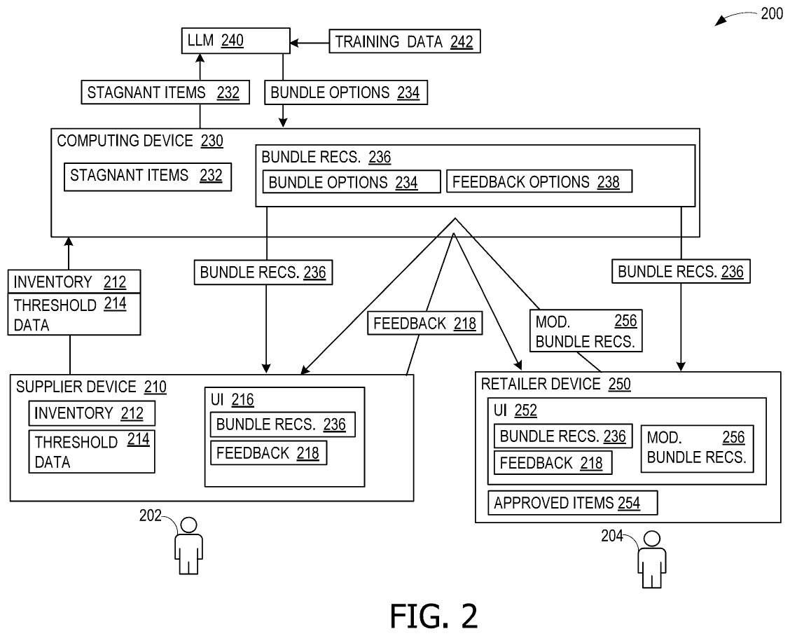

FIG. 2 is a block diagram illustrating an example architecture 200 for generating recommendations for selling unsold items, such as unsold items held by a supplier (represented as supplier 202) in inventory. Architecture 200 can include a supplier device 210 belonging to the supplier 202; a computing device 230 used for generating selling recommendations for the supplier's unsold inventory and coordination with a retailer (represented as retailer 204) for selling the unsold items; and a retailer device 250 belonging to the retailer 204. According to various examples, architecture 200 can be executed via system 100. For example, supplier device 210 and retailer device 250 can each comprise a user device 116, and computing device 230 can comprise computing device 102.

The supplier 202 can enter into or store at the supplier device 210 inventory data 212 (substantially the same as inventory data 130) related to items currently or planned to be in inventory at the supplier 202. Supplier 202 can also enter threshold data 214 (substantially the same as threshold data 132), which defines a threshold amount of time each item-type of the items in inventory data 212 is desired to remain in inventory before being analyzed by computing device 230 for selling recommendations. Supplier device 210 sends inventory data 212 and thresholds data 214 to computing device 230 for processing.

Using the inventory data 212 and threshold data 214, computing device 230 determines stagnant items 232 (substantially the same as stagnant items 136) included in the inventory data 212. Stagnant items 232 are items included in inventory data 212 that have been held in inventory by supplier 202 for longer than the defined threshold data 214 associated with the stagnant item 232. Stagnant items 232 can also be referred to herein as inactive items.

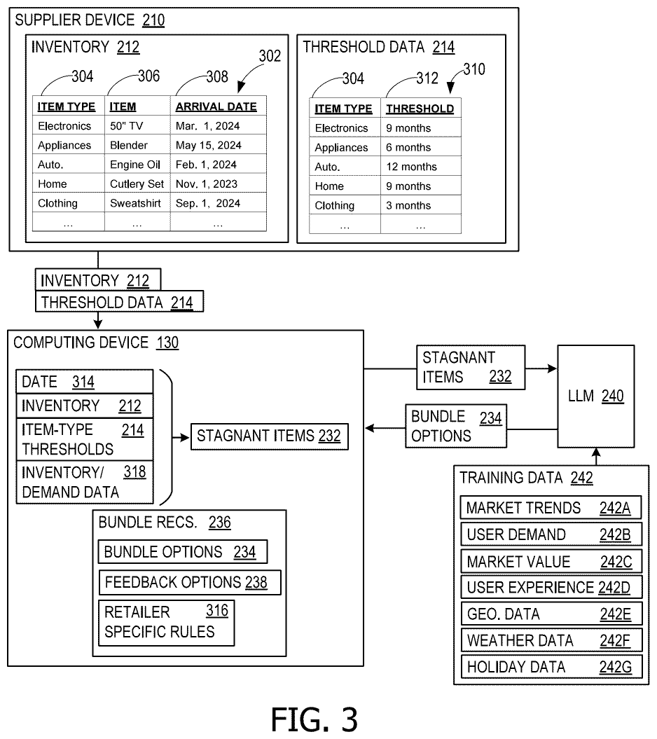

After determining the stagnant items 232, computing device 230 delivers stagnant items 232 to a large language model (LLM) 240 (substantially the same as LLM 122) as a prompt. According to various embodiments, LLM 240 is a generative artificial intelligence (AI) model. As those with skill in the art will understand, LLM 240 can comprise any known large language model, large multimodal model, AI model and/or generative AI model that allows for processing prompts with various parameters and that can also provide responses with various parameters. In some embodiments, LLM 240 comprises one or multiple of the models available via Large Language Model Meta AI (Llama), such as, for example, Llama 13B, 17B, or 70B. According to various examples, LLM 240 is trained with training data 242 comprising market trends related to the stagnant items 232 and other items included as part of supplier's 202 inventory, as will be discussed in greater detail in FIG. 3.

In response to the prompt, computing device 230 receives bundle options 234 (substantially the same as bundling options 138) from LLM 240. Bundle options 234 can include options for selling stagnant items 232 at a discounted price or as part of a bundle detail with multiple of the stagnant item 232 or with other similar items. That is, bundle options 234 can include any suggestion for selling the stagnant items 232 as part of a reduced-price or bundle deal based on the market trends and other data used as part of training data 242 in training LLM 240. Using bundle options 234, computing device 230 generates bundling recommendations 236 (substantially the same as bundling recommendations 126) for delivering to supplier device 210 and retailer device 250. Bundling recommendations 236 can include bundle options 234, and in some embodiments, can include additional data or preferences according to retailer 204 or supplier 202. In some embodiments, budling options 234 include multiple options, and bundling recommendations 236 can rank the options in a certain order based on retailer-or supplier-specific guidance or rules. In some example, computing device 230 includes feedback options 238 as part of bundling recommendations 236 that supplier 202 or retailer 204 can use to provide feedback related to the bundling recommendations 236. Computing device 230 the delivers recommendations 236 to supplier device 210 and retailer device 250 for presenting to supplier 202 and retailer 204, respectively.

At supplier device 210, bundling recommendations 236 are presented via a user interface (UI) 216. Via UI 216, supplier 202 can review feedback options 238 and provide feedback 218 related to the associated bundling recommendation 236. Feedback 218 is then delivered to retailer device 250 via computing device 230. That is, computing device 230 can be considered as an intermediary for facilitating communication between supplier device 210 and retailer device 250.

Retailer device 250 presents bundling recommendations 236 and feedback 218 via a UI 252. In response to feedback 218 indicating acceptance of the bundling recommendations 236, retailer device 250 and/or computing device 230 marks the items as approved for retail at the retailer 204 as an approved item 254. In response to feedback 218 indicating rejection or otherwise disapproving of the bundling recommendations 236, retailer 204 can, via UI 252, generate modified bundling recommendations 256 for supplier's 202 consideration. Retailer device delivers modified bundling recommendations 256 to supplier device 210 via computing device 230. That is, computing device 230 can be considered as an intermediary for facilitating communication between supplier device 210 and retailer device 250. Supplier 202 and retailer 204 can continue to send each other feedback 218 and modified bundling recommendations 256 until an agreement is ultimately made between or the parties, or until the parties decide no agreement can be reached.

As previously discussed, according to various examples of this disclosure, computing device 230 serves as an intermediary between supplier 202 and retailer 204. In some embodiments, computing device 230 is operated by retailer 204 and used as an intermediary for communicating with various suppliers 202. In some embodiments, computing device 230 utilizes a supplier hub that allows multiple suppliers 202 of retailer 204 to interact with the hub and provide the information related to the inventory data 212 discussed herein. Further, the supplier hub allows retailer 204 to provide various information to multiple suppliers 202, such as bundling recommendations 236, modified bundling recommendations 256, and/or bundle options 234, for example.

FIG. 3 is a block diagram illustrating how architecture 200 determines stagnant items 232 of supplier 202 and ultimately uses stagnant items 232 to determine bundle options 234. Inventory data 212 can comprise multiple pieces of data related to the inventory held by supplier 202, such as the information included in table 302, which illustrates various items in inventory and data related to those items. As shown, table 302 includes a list of items 306 in inventory. Additionally, in table 302 each item 306 is described using an item type 304, providing a categorical description of what kind of item the item 306 is. As shown in the FIG. 3 illustrative example, the “50-inch TV” item 306 has an item type 304 of “electronics”, the “blender” item 306 has an item type 304 of “appliances”, and so on. Additionally, each item 306 has an arrival date 308 value corresponding to a time the item 306 arrived in the supplier's 202 inventory. As those with skill in the art will understand, the items 306, item-type 304 descriptors, and arrival dates 308 illustrated in FIG. 3 are merely shown as illustrative examples, and various other item types and items appropriate for any of a number of different suppliers are included as part of this disclosure. Additionally, while non-perishable items are shown, architecture 200 can be utilized with inventories including perishable items as well.

Using threshold data 214, supplier 202 can designate how long each item type can stay in inventory before being considered by computing device 230 for bundling recommendations 236. As shown in table 310, supplier 202 can designate a threshold value 312 according to the item type 304. Supplier 202 has designated that, “electronics” item type 304 has a threshold of nine months, “appliances” item type 304 has a threshold value 312 of six months, and so on. As previously discussed, inventory data 212 and threshold data 214 is delivered to computing device 230 to determine stagnant items 232.

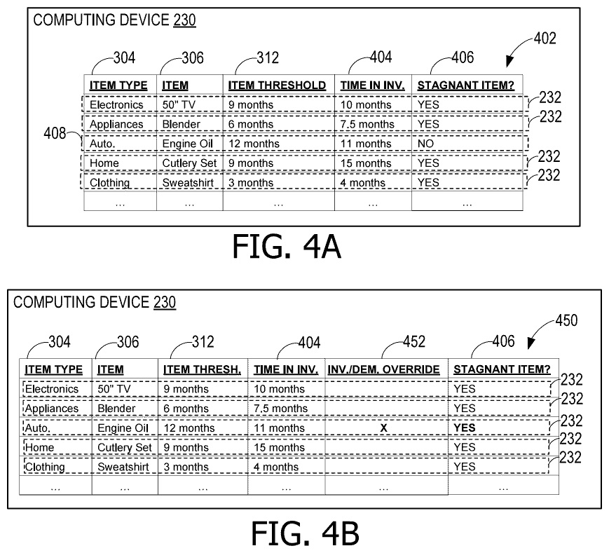

Upon receiving inventory data 212 and threshold data 214, computing device 230 uses the current date 314 to determine which items 306 in inventory data 212 have been in inventory longer than their associated threshold value 312, and label such items as a stagnant item 232. The determination of stagnant items 232 is shown in greater detail in FIGS. 4A and 4B. As previously discussed, computing device 230 sends stagnant items 232 to LLM 240 as part of prompt. LLM 240 is trained with training data 242 to return bundle options 234 to computing device 230 as a response to the prompt.

In some embodiments, stagnant items 232 are determined further using inventory and demand data 318 which can include inventory and demand data and trends related to inventory data 212. In some embodiments, inventory and demand data 318 includes the inventory turnover ratio (ITR) for each item 306, which gauges the efficiency of inventory management and is defined as the cost of goods sold divided by the average inventory. In some embodiments, inventory and demand data 318 includes the demand fulfilment ratio (DFR) for each item, which measures how well replenished items align with actual demand, and is defined by the actual quantity sold divided by the planned quantity to be sold. In some examples, an item 306 is considered by computing device 230 to be stagnant using inventory and demand data 318 even if the item is not considered to be stagnant according to the corresponding threshold value 312, as will be discussed in greater detail in FIG. 4B. In some embodiments, part or all of inventory and demand data 318 is provided to computing device 230 by LLM 240, which is trained using market demands and trends, as discussed in greater detail below.

LLM 240 is trained using various types of training data 242 related to stagnant items 232. As shown training data 242 can include market trends 242A data related to the demand patterns of the items; user demand 242B data related to user interactions and demands at in-store or online platforms of retailer 204; market value 242C data related to the current market value of the items; user experience 242D data related to user buying experiences, reviews, and rating associated with the items; graphical data 242E related to how the items may perform based on the geographical region; weather data 242F related to how an item's marketability may be affected based on local weather conditions; and holiday data 242G related to how an item's marketability may be affected based on regional, national, or religious holidays. These are just some of the data that can be included in training data 242 for training LLM 240. According to various examples of this disclosure, LLM 240 can be trained with more or less than the training data 242 discussed herein related to stagnant items 232.

Using bundle options 234, computing device 230 generates bundling recommendations 236, which includes bundle options 234, feedback options 238, and other retailer-specific rules 316 related to forming bundling recommendations 236. Bundle options 234 can comprise many different forms. In some embodiments, a bundle option 234 can comprise a candidate item of stagnant items 232 offered at a discounted price. In some embodiments a bundle option 234 can include multiple of a same stagnant item 232 offered to be sold together at a discount price. In some embodiments, a bundle option 234 can include a first stagnant item 232 paired to be sold as part of a bundle deal with a different second stagnant item 232, such as another stagnant item 232 having the same item type 304 as the first stagnant item 232—for example, a bundle option 234 could include a cell phone bundled with a set of headphones. Retailer-specific rules 316 can comprise rules for ordering the multiple bundle options 234 associated with a stagnant item 232. For example, for a cell phone stagnant item 232, retailer-specific rules 316 can dictate to prioritize a bundle option 234 that suggests offering the cell phone for sale at a discounted price as a preferred bundle option 234, and can dictate to understate a bundle option 234 that suggests offering the cell phone for sale as a bundle deal with a set of headphones as a secondary bundle option 234. In some embodiments, these retailer-specific rules 316 can be defined by retailer 204 and stored at computing device 230.

FIG. 4A is provided to illustrate computing device's 230 determination of stagnant items 232 included in inventory data 212. Computing device 230 uses the current date 314 and arrival date 308 of each item 306 to determine an inventory time 404 for each item 306 corresponding to a length of time the item 306 has been held in inventory at supplier 202. Computing device 230 compares inventory time 404 to the threshold value 312 associated with the item 306. If the item's 306 inventory time 404 is greater than the associated threshold value 312 for the item type 304, the item 306 is identified as a stagnant item 232, as shown in column 406. If the item's 306 inventory time 404 is less than the associated threshold value 312 for the item type 304, the item 306 is not identified as a stagnant item 232, as shown in column 406. Although a table 402 is used to show the determination of stagnant items 232, those with skill in the art will understand table 402 is shown for illustrative purposes, and various other logic can be used in determining stagnant items 232. Additionally, computing device 230 can determine that any items included in inventory data 212 that are not stagnant items 232 are active items 408. That is, any items 306 that have been in inventory at the supplier 202 less than the associated threshold value 312 can be considered by computing device 230 as an active item 408. As shown, item 306 “engine oil” is identified as an active item 408 because the associated inventory time 404 is less than the corresponding threshold value 312.

FIG. 4B is provided to illustrate computing device's 230 determination of stagnant items 232 included in inventory data 212 using table 450, which is substantially the same as table 402 shown in FIG. 4A. Notably, table 450 includes inventory/demand override section 452. For each item 306, in addition to considering the associated threshold value 312, computing device 230 further considers the associated inventory and demand data 318 such as the ITR and DFR associated with the item 306. If the inventory and demand data 318 indicates that the current market, demand, and inventory conditions are ideal for selling the item, computing device 230 marks inventory/demand override section 452 for the item 306, and the item 306 is given a stagnant item classification. As shown, item 306 “engine oil” is designated with an “X” in inventory/demand override section 452 based on its associated inventory and demand data 318 and is thus labeled as a stagnant item 232 even though its inventory time 404 is less than its associated threshold value 312.

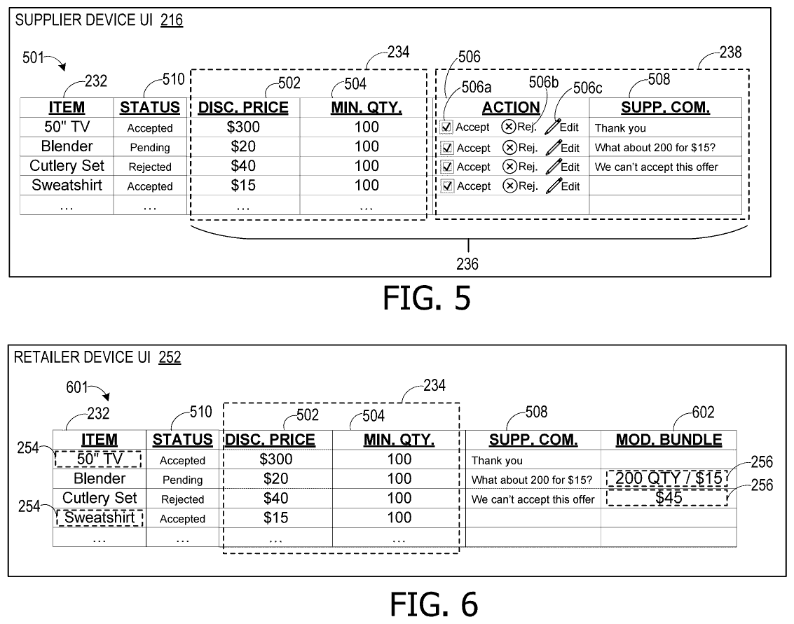

FIG. 5 illustrates the UI 216 of supplier device 210 presenting an exemplary table 501. Table 501 presents the stagnant items 232 identified in FIGS. 3 and 4. Table 501 further includes the bundling recommendations 236 generated by computing device 230, which, in the illustrative example, includes bundle options 234 and feedback options 238. In this illustrative example the bundle option 234 for each stagnant item 232, which is generated by the LLM 240, includes a discount price 502 and a minimum quantity 504 of the items required to offer at the discount price 502. That is, the bundle option 234 from the LLM 240 comprises an offer to the supplier 202 to offer the stagnant item 232 at a discount price 502 given the supplier can provide the minimum quantity 504 of the stagnant item 232. The discount price 502 is a price of the stagnant item 232 discounted from its original retail price. For example, looking at the “50-inch TV” stagnant item 232 of FIG. 5, the discount price 502 of the TV is $300, and the original retail price may have been $500.

In some embodiments, feedback options 238 for each stagnant item 232 includes an action section 506 where the supplier 202 can select from different actions related to the bundle option 234 for each stagnant item 232. As shown, the action section 506 can include an accept button 506a for accepting the bundle option 234, a rejection button 508a for rejecting the bundle option 234, and an edit button 506c for requesting a change to the bundle option 234. Additionally, supplier 202 can enter feedback via a supplier comment section 508. Additionally, table 501 includes a status section 510 that reflects the supplier's 202 feedback via feedback options 238. As shown, for stagnant items 232 “50-inch TV” and “sweatshirt”, supplier 202 selected accept button 506a to accept the bundle option 234, and the respective status sections 510 are updated to “approved” based on the selection of accept button 506a. As shown, for stagnant item 232 “cutlery set”, supplier 202 selected rejection button 506b to reject the bundle option 234, and the respective status section 510 is updated to “rejected” based on the selection of reject button 506b. Additionally, the supplier 202 has left a message for the retailer 204 in supplier comment section 508 indicating that the offer cannot be accepted by supplier 202. As shown, for stagnant item 232 “blender”, supplier 202 selected edit button 506c to request a modification to the bundle option 234, and the respective status section 510 is updated to “pending” based on the selection of edit button 506c. Additionally, the supplier 202 has left a message for the retailer 204 in supplier comment section 508 indicating their requested modification to the bundling option 534. Here, as shown, supplier 202 requests to increase the minimum quantity 504 to 200 units at a price of $15 per unit.

FIG. 6 illustrates the UI 252 of retailer device 250 presenting an exemplary table 601. As shown, table 601 corresponds with various details of table 501, previously discussed. Table 601 includes the stagnant items 232, status section 510, bundle options 234 including the discount price 502 and the minimum quantity 504, and supplier comment section 508. Accordingly, the retailer 204 can view whether the bundle option 234 for a stagnant item 232 has been accepted via status section 510 and can also view any comments from the supplier related to the offer via supplier comment section 508. For each stagnant item 232, the retailer 204 can modify the bundle option 234 using modified bundle section 602. For example, in response to the pending status and supplier's 202 comment in supplier comment section 508 for stagnant item 232 “blender”, a user of retailer device 250 has updated the modified bundle section 602 to reflect the requested offer as a modified bundling recommendation 256, which is sent back to the supplier device 210 for supplier 202 to review and accept (as discussed in FIG. 2). In response to the rejection status and supplier's 202 comment in supplier comment section 508 for stagnant item 232 “cutlery set”, a user of retailer device 250 has updated the modified bundle section 602 to a new offer as a modified bundling recommendation 256, which is sent back to the supplier device 210 for supplier 202 to review and accept (as discussed in FIG. 2). A user of retailer device 250 can update modified bundle section 602 to provide modified bundling recommendations 256 at any time, such as when the status for the bundle option 234 is pending, rejected, accepted, for example. For each stagnant item 232 whose bundle option 234 was accepted by the supplier 202, such as the “50-in TV” and “sweatshirt” stagnant items 232 illustrated, retailer device 250 and/or computing device 230 labels the accepted stagnant items 232 an approved item 254 approved for sale according to the associated bundle options 234.

Those with skill in the art will recognize that FIGS. 5 and 6 provide just some of various examples of bundle options 234 and bundling recommendations 236 of this disclosure. Bundle options 234 of FIGS. 5 and 6 show each stagnant item 232 offered at a discount price 502 for a minimum quantity 504. However, as previously discussed, bundle options 234 can include various other embodiments, such as pairing a first stagnant items 232 with a second or multiple different stagnant items 232 related to the first stagnant item 232 as part of a bundle deal. Bundle options 234 can further include a single stagnant item 232 offered at a discounted price, stagnant items 232 offered as a buy-on-get-one-free deal, or discount offers for another item with the purchase of a stagnant item 232. Further, bundling recommendations 236 can include a ranking or ordering of multiple bundle options 234 for each stagnant items 232 based retailer-specific rules 316 or an order provided by LLM 240. Accordingly, those with skill in the art will recognize that FIGS. 5 and 6 are illustrative examples, and that various other examples fall within the scope of this disclosure.

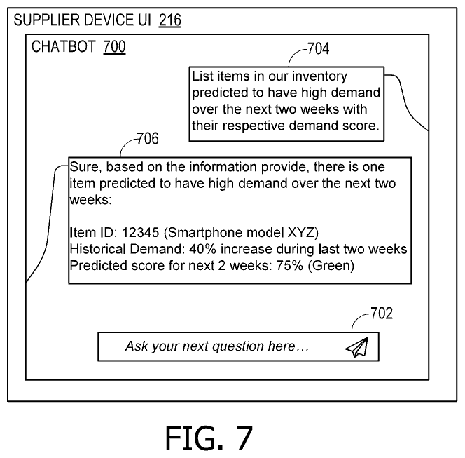

FIG. 7 illustrates a chatbot window 700 that can be incorporated with architecture 200 and can be accessible via supplier device 210 and retailer device 250. According to various examples, chatbot window 700 can be considered an “AI chatbot” and performed by computing device 230 operatively coupled with LLM 240 to provide data related to bundle options 234, stagnant items 232, or other inventory-related questions asked by a user of supplier device 210 or retailer device 250. As shown, in this illustrative example, chatbot window 700 is being accessed by supplier device 210 via UI 216. A user can enter a question or command via chat section 702, which is then displayed as a user comment 704. In response to the user comment 704, computing device 230 replies with a chatbot comment 706. As previously discussed, computing device 230 can utilize LLM 240 in forming chatbot comments 706. As shown, in this illustrative example, a user of supplier device 210 has provided a command to list product expected to have a high demand over the next two weeks in user comment 704, and computing device 230 has provided an associated response via chatbot comment 706. Chatbot window 700 can also be used to ask clarifying questions or provide commands related to bundle options 234 provided by LLM 240.

FIG. 8 illustrates a method 800 for generating recommendations for selling unsold items, such as method operable by computing device 230, for example. The process shown in FIG. 8 is performed by bundling manager component 120, executing on a computing device, such as the computing device 102 or the user device 116 in FIG. 1.

Method 800 can start at block 802 by receiving data associated with a plurality of stagnant items 232, such as inventory data 212 and threshold data 214, for example. Method 800 can continue to block 804 where computing device 230 analyzes the received data an AI model, such as LLM 240, to identify candidate items of the stagnant items 232 for including in a bundle options 234. Method 800 can continue to block 806 by generating a bundling recommendation 236 including the bundle option 234, which includes candidate items from the stagnant items 232. Method 800 can continue to block 808 where computing device 230 presents the bundling recommendation 236, such as via supplier device 210 and/or retailer device 250. Where the bundling recommendation 236 can include or be presented along with feedback options 238, such as, for example, accept button 506a, rejection button 506b, and edit button 506c.

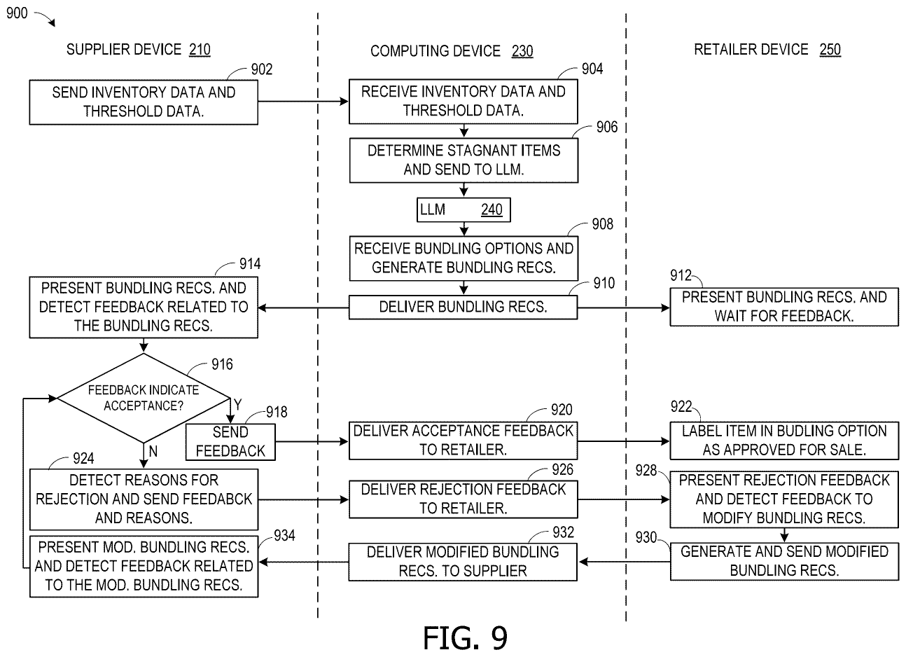

FIG. 9 illustrates a method 900 for generating recommendations for selling unsold items, such as method operable by architecture 200, for example. Method 900 can begin at block 902 by supplier device 210 sending inventory data 212 and threshold data 214 to computing device 230, where the inventory data 212 and threshold data 214 is received by computing device 230 at block 904. Method 900 continues to block 906 where, using inventory data 212 and threshold data 214, computing device 230 determines stagnant items 232 included as part of inventory data 212 and sends stagnant items 232 as part of a prompt to LLM 240. Method 900 continues to block 908 where computing device 230, in response to providing the prompt to LLM 240, receives a response from LLM 240 including bundle options 234. Block 908 further includes computing device 230 generating bundling recommendations 236 including the bundle options 234. Method 900 continues to block 910 by delivering bundling recommendations 236 to supplier device 210 and retailer device 250.

Method 900 continues to block 912 where retailer device 250 receives and presents bundling recommendations 236 to a user of retailer device 250. Additionally, at block 914, supplier device 210 receives and presents bundling recommendations 236 to a user of supplier device 210 and detects the user's selection of feedback options 238 included in bundling recommendations 236. In block 916, in response to detecting acceptance of one of the bundle options 234 in bundling recommendations 236, such as by detecting selection of accept button 506a for example, method 900 continues to block 918 by sending the detected feedback to computing device 230. Method 900 continues to block 920 where computing device 230 delivers the detected acceptance feedback to retailer device 250. Method 900 continues block 922 where retailer device 250 labels the stagnant item 232 included in the accepted bundle options 234 as an approved item 254 for sale. In some embodiments, as part of block 920 and/or 922, computing device 230 detects the acceptance feedback and also updates the associated stagnant item 232 as an approved item 254.

Referring back to block 916, in response to determining that the detected feedback does not indicate acceptance, method 900 continues to block 924 where supplier device 210 detects reasons for rejection. For example, supplier device 210 can detect the user's selection of selected rejection button 506b or edit button 506c or text added to supplier comment section 508 in block 924. Block 924 further includes sending the detected reasons for rejection to computing device 230 and method 900 can continue at block 926 where computing device 230 sends the detected reasons for rejection to retailer device 250. Method 900 continues to block 928 where retailer device 250 presents the detected rejection feedback to a user of retailer device 250. For example, the reasons for rejection can be presents in table 601 in status section 510 and/or supplier comment section 508.

Method 900 can continue to block 930 where retailer device 250 generates modified bundling recommendations 256. For example, retailer device 250 can use information entered by a user into modified bundle section 602 of table 601 to generate modified bundling recommendations 256. Block 930 further includes sending modified bundling recommendations 256 to computing device 230, and method 900 continues to block 932 where computing device 230 delivers modified bundling recommendations 256 to supplier device 210. Method 900 continues to block 934 where the supplier device 210 presents the modified bundling recommendations 256 received to a user of supplier device 210 and detects feedback from the user entered related to modified bundling recommendations 256 via back options 238. From there, method 900 can continue back to block 916 where supplier device 210 determines whether the feedback detected indicates acceptance or rejection. Those with skill in the art will recognize that block 916-934 can be repeated multiple times until an offer is accepted the stagnant item 232 is labeled as an approved item 254, the supplier 202 make a final rejection, the retailer 204 decides not to make any further modified bundling recommendations 256, or the cycle is otherwise stopped.

Those with skill in the art will understand that while method 900 depicts blocks 902-934 occurring in a certain order, blocks 902-934 can be performed according to any of a number of orders without departing from the scope of this disclosure. Additionally, method 900 can include more or less than the blocks 902-934 depicted without departing from the scope of this disclosure.

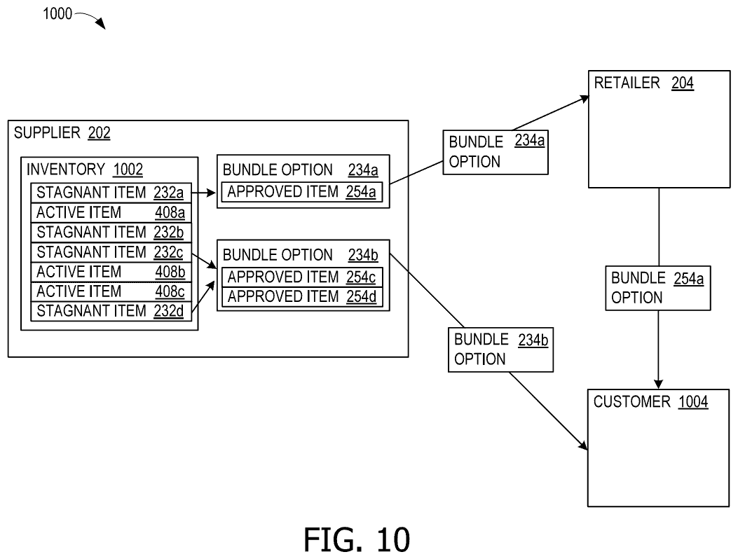

FIG. 10 is a block diagram illustrating an exemplary operating environment 1000 in which the architectures and methods discussed herein, such as architecture 200 and methods 800, 900, for example, can be implemented. As shown, operating environment 1000 includes supplier 202, retailer 204, and a customer 1004, who can be a customer of retailer 204. For operating environment 1000, supplier 202 can be a warehouse, office, distribution center, store, or any other structure of supplier used for housing an inventory 1002 of supplier's 202 items. For operating environment 1000, retailer 204 can be a store, warehouse, distribution center, office, or any other structure belonging to retailer 204 for receiving, selling, or distributing items to customer 1004. Those with skill in the art will understand that while operating environment 1000 depicts one of each the supplier 202, retailer 204, and customer 1004, various operating environments incorporating multiple of each of the supplier 202, retailer 204, and customer 1004 are included as part of this disclosure, and operating environment 1000 is merely one illustrative example of an operating environment for showing movement of items between supplier 202, retailer 204, and customer 1004.

As shown, inventory 1002 can include multiple stagnant items 232 and also multiple active items 408. Once stagnant items 232 are labeled as approved items 254, they can be delivered from supplier 202 according to their bundle option 234. As shown, for example, bundle option 234a includes approved item 254a, which started as stagnant item 232a. As another example, bundle option 234b includes approved items 254c and 254d, which started as stagnant items 232c and 232d, respectively.

Customer 1004 can then purchase the approved items 254 according to their respective bundle option 234. In some embodiments, the customer 1004 can purchase the bundle options on-line through a website or device application of the retailer's 204. In some embodiments, after purchasing the bundle option 234 online, the bundle option 234 is delivered from the supplier 202 directly to customer 1004 (as shown with bundle option 234b). In some embodiments, after purchasing the bundle option 234 online, the bundle options 234 is delivered from the supplier 202 to retailer 204 (such as to a distribution center of the retailer 204, for example) and then to customer 1004 (as shown with bundle option 234a). In some embodiments, customer 1004 may purchase the bundle option 234 online, and the bundle option 234 can be shipped from supplier 202 to a store of retailer 204 near customer 1004 for the customer 1004 to pick up at the store.

Still, in some embodiments, retailer 204 may preemptively purchase bundle options 234 from supplier 202 without a corresponding purchase from customer 1004 and keep the bundle options 234 at retailer 204 (such as in a distribution center, inventory warehouse, or in-store shelving, for example) for a customer 1004 to purchase from retailer 204. Thus, in these embodiments, retailers 204 are able to acquire items from their suppliers 202 at a deeply discounted prices below the traditional wholesale price, and thus achieve greater margins on the items than they would otherwise.

Although described in connection with an example computing device 102, 230, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system utilizing an artificial intelligence (AI) model to reduce storage resource utilization, comprising:
a processor; and
a computer-readable medium storing instructions operative by the processor to:
receive data associated with a plurality of stagnant items determined inactive for a threshold time;
use an AI model trained using data related to the plurality of stagnant items, analyze the data associated with the plurality of stagnant items to identify at least one candidate item of the plurality of stagnant items for including in a bundling option;
generate a bundling recommendation including the bundling option, wherein the bundling option includes the at least one candidate item; and
present the bundling recommendation along with an acceptance indicator for accepting the bundling recommendation and a rejection indicator for rejecting the bundling recommendation.

2. The system of claim 1, wherein the computer-readable medium further stores instructions operative by the processor to:
in response to detecting a selection of the acceptance indicator, update a status of the at least one candidate item from inactive to approved for bundling.

3. The system of claim 1, wherein the computer-readable medium further stores instructions operative by the processor to:
in response to detecting a selection of the rejection indicator:
persist a status of the at least one candidate item as inactive, and
detect whether feedback related to a reasoning for the selection of the rejection indicator is received.

4. The system of claim 3, wherein the computer-readable medium further stores instructions operative by the processor to:
in response to detecting that the feedback related to the reasoning for the selection of the rejection indicator is received, present the feedback to a user for creating a modified bundling recommendation based on the feedback.

5. The system of claim 1, wherein the computer-readable medium further stores instructions operative by the processor to:
determine an item type for each of the plurality of stagnant items; and
include in the bundling option the at least one candidate item and another candidate item belonging to a same item type as the at least one candidate item.

6. The system of claim 1, wherein the computer-readable medium further stores instructions operative by the processor to:
receive data related to a plurality of items, the plurality of items including the plurality of stagnant items and a plurality of active items.

7. The system of claim 6, wherein the computer-readable medium further stores instructions operative by the processor to determine which of the plurality of items are stagnant items and which of the plurality of items are active items by:
determining an item-type for each of the plurality of items;
determining an item-type-threshold for each item-type;
determining and inactive time for each of the plurality of items related to a duration of time that the item has been inactive;
for each of the plurality of items, in response to determining that the inactive time for the item is larger than the item-type-threshold for the item-type of the item, identifying the item as stagnant; and
for each of the plurality of items, in response to determining that the inactive time for the item is less than the item-type-threshold for the item-type of the item, identifying the item as active.

8. A method for utilizing an artificial intelligence (AI) model to reduce storage resource utilization, comprising:
receiving data associated with a plurality of stagnant items determined inactive for a threshold time;
using an AI model trained using data related to the plurality of stagnant items, analyze the data associated with the plurality of stagnant items to identify at least one candidate item of the plurality of stagnant items for including in a bundling option;
generating a bundling recommendation including the bundling option, wherein the bundling option includes the at least one candidate item; and
presenting the bundling recommendation along with an acceptance indicator for accepting the bundling recommendation and a rejection indicator for rejecting the bundling recommendation.

9. The method of claim 8, further comprising:
in response to detecting a selection of the acceptance indicator, updating a status of the at least one candidate item from inactive to approved for bundling.

10. The method of claim 8, further comprising:
in response to detecting a selection of the rejection indicator:
persisting a status of the at least one candidate item as inactive, and
detecting whether feedback related to a reasoning for the selection of the rejection indicator is received.

11. The method of claim 10, further comprising:
in response to detecting that the feedback related to the reasoning for the selection of the rejection indicator is received, presenting the feedback to a user for creating a modified bundling recommendation based on the feedback.

12. The method of claim 8, further comprising:
determining an item type for each of the plurality of stagnant items; and
include in the bundling option the at least one candidate item and another candidate item belonging to a same item type as the at least one candidate item.

13. The method of claim 8, further comprising:
receiving data related to a plurality of items, the plurality of items including the plurality of stagnant items and a plurality of active items.

14. The method of claim 13, further comprising determining which of the plurality of items are stagnant items and which of the plurality of items are active items by:
determining an item-type for each of the plurality of items;
determining an item-type-threshold for each item-type;
determining and inactive time for each of the plurality of items related to a duration of time that the item has been inactive;
for each of the plurality of items, in response to determining that the inactive time for the item is larger than the item-type-threshold for the item-type of the item, identifying the item as stagnant; and
for each of the plurality of items, in response to determining that the inactive time for the item is less than the item-type-threshold for the item-type of the item, identifying the item as active.

15. A computer-readable medium storing instructions for utilizing an artificial intelligence (AI) model to reduce storage resource utilization, the instructions operative by a processor to:
receive data associated with a plurality of stagnant items determined inactive for a threshold time;
use an AI model trained using data related to the plurality of stagnant items, analyze the data associated with the plurality of stagnant items to identify at least one candidate item of the plurality of stagnant items for including in a bundling option;
generate a bundling recommendation including the bundling option, wherein the bundling option includes the at least one candidate item; and
present the bundling recommendation along with an acceptance indicator for accepting the bundling recommendation and a rejection indicator for rejecting the bundling recommendation.

16. The computer-readable medium of claim 15, further storing instructions operative by the processor to:
in response to detecting a selection of the acceptance indicator, update a status of the at least one candidate item from inactive to approved for bundling.

17. The computer-readable medium of claim 15, further storing instructions operative by the processor to:
in response to detecting a selection of the rejection indicator:
persist a status of the at least one candidate item as inactive, and
detect whether feedback related to a reasoning for the selection of the rejection indicator is received.

18. The computer-readable medium of claim 17, further storing instructions operative by the processor to:
in response to detecting that the feedback related to the reasoning for the selection of the rejection indicator is received, present the feedback to a user for creating a modified bundling recommendation based on the feedback.

19. The computer-readable medium of claim 15, further storing instructions operative by the processor to:
determine an item type for each of the plurality of stagnant items; and
include in the bundling option the at least one candidate item and another candidate item belonging to a same item type as the at least one candidate item.

20. The computer-readable medium of claim 15, further storing instructions operative by the processor to:
receive data related to a plurality of items, the plurality of items including the plurality of stagnant items and a plurality of active items; and
determine which of the plurality of items are stagnant items and which of the plurality of items are active items by:
determining an item-type for each of the plurality of items;
determining an item-type-threshold for each item-type;
determining and inactive time for each of the plurality of items related to a duration of time that the item has been inactive;
for each of the plurality of items, in response to determining that the inactive time for the item is larger than the item-type-threshold for the item-type of the item, identifying the item as stagnant; and
for each of the plurality of items, in response to determining that the inactive time for the item is less than the item-type-threshold for the item-type of the item, identifying the item as active.
